(19) United States
(12) Patent Application Publication
(10) Pub. No.: US 2021/0240469 A1
(43) Pub. Date: Aug. 5, 2021

(54) METHOD AND APPARATUS FOR MANAGING MODULES

(71) Applicant: Electronics and Telecommunications Research Institute, Daejeon (KR)

(72) Inventors: Minh Chau NGUYEN, Daejeon (KR); Hee Sun WON, Daejeon (KR)

(73) Assignee: Electronics and Telecommunications Research Institute, Daejeon (KR)

(21) Appl. No.: 17/157,226

(22) Filed: Jan. 25, 2021

(30) Foreign Application Priority Data
Feb. 5, 2020 (KR) 10-2020-0013476
Dec. 30, 2020 (KR) 10-2020-0187191

(51) Int. Cl. G06F 8/70; G06F 16/245; G06F 9/54

(52) U.S. Cl. CPC G06F 8/70; G06Q 10/101; G06F 9/541; G06F 16/245

(57) ABSTRACT

A method for managing modules, performed by a module management apparatus, may comprise receiving a module generation request from a user; generating a module according to the module generation request and transmitting the module to the user; receiving a module registration request from the user; and registering the module according to the module registration request.

### CROSS-REFERENCE TO RELATED APPLICATIONS

This application claims priority to Korean Patent Applications No. 10-2020-0013476 filed on Feb. 5, 2020 and No. 10-2020-0187191 filed on Dec. 30, 2020 with the Korean Intellectual Property Office (KIPO), the entire contents of which are hereby incorporated by reference.

### BACKGROUND

### 1. Technical Field

The present disclosure relates to a method and an apparatus for managing modules, and more specifically, to a method and an apparatus for managing modules in a smart data platform, which can satisfy user requirements.

### 2. Related Art

Today's big data era began with the efforts of theorists, people and scientists who build systems, and the like. In particular, with the advent of the big data era, as the amount of data increases and various demands for data increase, it is necessary to develop a system that provides various functions. Also, the functions included in such the system have specific purposes and are problematic because they provide different interfaces using different data models and different APIs. Therefore, in order to solve the above problem, a platform based on modules that provide various functions is being utilized.

In such the module-based platform, each function may be provided by one or a plurality of modules, and may be replaced by a plugin mechanism as shown in FIG. 1. However, in the module-based platform, it is complicated and difficult to use the modules, there is a problem that a user should configure the modules through numerous steps before using the platform, and it is difficult to add or update a new module to the platform.

### SUMMARY

In order to solve the above-identified problems, exemplary embodiments of the present disclosure are directed to providing a platform that can satisfy various requirements of a user by sharing, using, and combining functions which the user can easily use.

According to an exemplary embodiment of the present disclosure for achieving the above-described objective, a method for managing modules, performed by a module management apparatus, may comprise: receiving a module generation request from a user; generating a module according to the module generation request and transmitting the module to the user; receiving a module registration request from the user; and registering the module according to the module registration request.

The method may further comprise generating a module list for the module registered according to the module registration request.

The module list may be composed of a plurality of modules associated with a function performed by the generated module for which the registration is requested.

The method may further comprise generating a smart data platform including a plurality of modules.

The generating of the smart data platform may comprise: receiving a smart data platform generation request from a user; transmitting a module list including a plurality of modules to the user; receiving information on a module selected from the module list from the user; and generating the smart data platform based on the information on the selected module.

The information on the module selected from the module list may be information on the module selected by the user from the module list through a keyword search.

According to another exemplary embodiment of the present disclosure for achieving the above-described objective, a module management apparatus may comprise a processor;

and a memory storing at least one instruction executable by the processor, and when executed by the processor, the at least one instruction may cause the module management apparatus to: receive a module generation request from a user; generate a module according to the module generation request and transmit the module to the user; receive a module registration request from the user; and register the module according to the module registration request.

The at least one instruction may further cause the module management apparatus to generate a module list for the module registered according to the module registration request.

The module list may be composed of a plurality of modules associated with a function performed by the generated module for which the registration is requested.

The at least one instruction may further cause the module management apparatus to generate a smart data platform including a plurality of modules.

In the generating of the smart data platform, the at least one instruction may further cause the module management apparatus to: receive a smart data platform generation request from a user; transmit a module list including a plurality of modules to the user; receive information on a module selected from the module list from the user; and generate the smart data platform based on the information on the selected module.

The information on the module selected from the module list may be information on the module selected by the user from the module list through a keyword search.

According to an exemplary embodiment of the present disclosure, it is possible to conveniently develop and extend a system by generating a platform including various modules. According to another exemplary embodiment of the present disclosure, a platform including functions for satisfying the user's system requirements may be generated by generating and registering modules desired by the user.

### BRIEF DESCRIPTION OF DRAWINGS

FIG. 1 is a conceptual diagram of a smart data platform including a plurality of modules.

FIG. 2 is a first block diagram of a module management apparatus according to an exemplary embodiment of the present disclosure.

FIG. 3 is an exemplary diagram of a core database.

FIG. 4 is a second block diagram of a module management apparatus according to an exemplary embodiment of the present disclosure.

FIG. 5 is an operational flowchart illustrating a module management method according to another exemplary embodiment of the present disclosure.

FIG. 6 is an operational flowchart illustrating a method of generating a smart data platform.

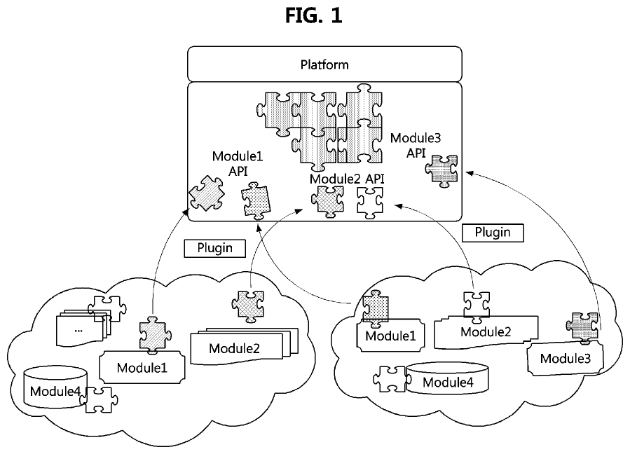

### DETAILED DESCRIPTION OF THE EMBODIMENTS

Embodiments of the present disclosure are disclosed herein. However, specific structural and functional details disclosed herein are merely representative for purposes of describing embodiments of the present disclosure. Thus, embodiments of the present disclosure may be embodied in many alternate forms and should not be construed as limited to embodiments of the present disclosure set forth herein.

Accordingly, while the present disclosure is capable of various modifications and alternative forms, specific embodiments thereof are shown by way of example in the drawings and will herein be described in detail. It should be understood, however, that there is no intent to limit the present disclosure to the particular forms disclosed, but on the contrary, the present disclosure is to cover all modifications, equivalents, and alternatives falling within the spirit and scope of the present disclosure. Like numbers refer to like elements throughout the description of the figures.

It will be understood that, although the terms first, second, etc. may be used herein to describe various elements, these elements should not be limited by these terms. These terms are only used to distinguish one element from another. For example, a first element could be termed a second element, and, similarly, a second element could be termed a first element, without departing from the scope of the present disclosure. As used herein, the term “and/or” includes any and all combinations of one or more of the associated listed items.

It will be understood that when an element is referred to as being “connected” or “coupled” to another element, it can be directly connected or coupled to the other element or intervening elements may be present. In contrast, when an element is referred to as being “directly connected” or “directly coupled” to another element, there are no intervening elements present. Other words used to describe the relationship between elements should be interpreted in a like fashion (i.e., “between” versus “directly between,” “adjacent” versus “directly adjacent,” etc.).

The terminology used herein is for the purpose of describing particular embodiments only and is not intended to be limiting of the present disclosure. As used herein, the singular forms “a,” “an” and “the” are intended to include the plural forms as well, unless the context clearly indicates otherwise. It will be further understood that the terms “comprises,” “comprising,” “includes” and/or “including,” when used herein, specify the presence of stated features, integers, steps, operations, elements, and/or components, but do not preclude the presence or addition of one or more other features, integers, steps, operations, elements, components, and/or groups thereof.

Unless otherwise defined, all terms (including technical and scientific terms) used herein have the same meaning as commonly understood by one of ordinary skill in the art to which this present disclosure belongs. It will be further understood that terms, such as those defined in commonly used dictionaries, should be interpreted as having a meaning that is consistent with their meaning in the context of the relevant art and will not be interpreted in an idealized or overly formal sense unless expressly so defined herein.

Hereinafter, exemplary embodiments of the present disclosure will be described in greater detail with reference to the accompanying drawings.

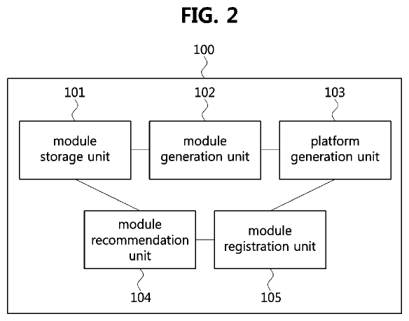

FIG. 2 is a first block diagram of a module management apparatus according to an exemplary embodiment of the present disclosure.

As shown in FIG. 2, a module management apparatus 100 according to an exemplary embodiment of the present disclosure may comprise a module storage unit 101, a module generation unit 102, a platform generation unit 103, a module recommendation unit 104, and a module registration unit 105.

The module storage unit 101 may store a plurality of modules configured in a tree structure. For example, if a module 1 is composed of a module 1.1 and a module 1.2, they may be stored as configured in a tree structure. Meanwhile, each module may include an API validator, an API processor, and an API hooker.

Here, the API validator may check whether API compatibility is valid through authentication, authorization, and input validation. In addition, the API processor may declare access information for methods, endpoints, and the like, and may include codes for executing main logics of the API. Meanwhile, the API hooker may execute additional logics before or after execution of the specific API.

The module generation unit 102 may generate a new module according to a user's request. Meanwhile, the platform generation unit 103 may generate a new smart data platform according to a user's request.

The module recommendation unit 104 may provide a list of suitable modules based on a user's input. In this case, the module list may be composed of a plurality of modules associated with a function performed by a module that is generated according to the user's request or for which registration is requested by the user.

The module registration unit 105 may register and store the module generated according to the user's request in the module storage unit 101.

Meanwhile, the newly generated platform may include a package, a plugin, a core processor, and a core database. Each module stored in the module storage unit 101 may be used as a package of the newly generated platform to provide a new function, and may be used as a plugin to replace an existing function of the platform.

Meanwhile, the core processor may include major logics of the platform such as logging and exception handling. In addition, the core database may store metadata and data.

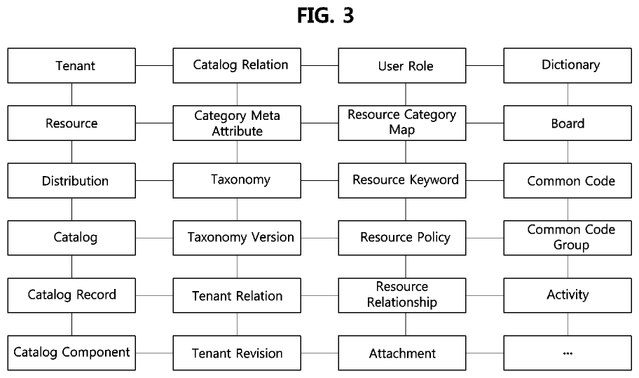

FIG. 3 is an exemplary diagram of a core database.

As shown in FIG. 3, the core database may store information on tenants, resources, distribution, catalog, catalog record, catalog component, catalog relationship, catalog meta- attribute, taxonomy, taxonomy version, tenant relation, tenant revision, user role, resource category map, resource policy, resource relationship, attachment, dictionary, board, common code, common code group, and/or activity.

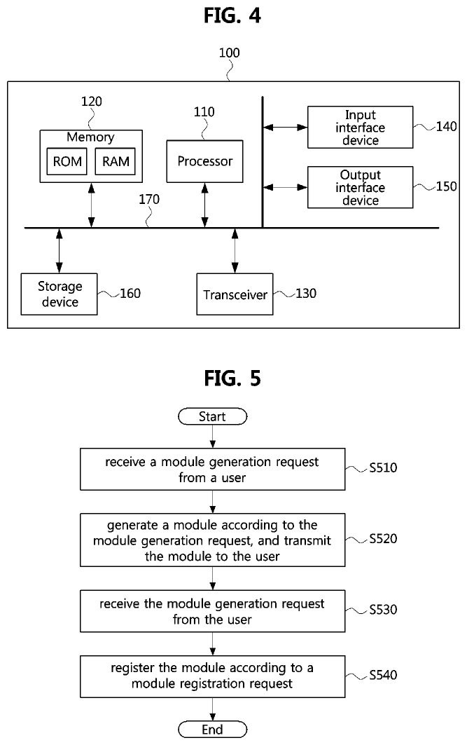

FIG. 4 is a second block diagram of a module management apparatus according to an exemplary embodiment of the present disclosure.

As shown in FIG. 4, the module management apparatus 100 according to an exemplary embodiment of the present disclosure may comprise a processor 110, a memory 120 for storing at least one instruction executable by the processor and results of execution of the at least one instruction, and a transceiver 130 connected to a network for performing communications.

The module management apparatus 100 may further comprise an input interface device 140, an output interface device 150, a storage device 160, and the like. Each component included in the module management apparatus 100 may communicate with each other as connected through a bus 170. However, each component included in the module management apparatus 100 may be connected to the processor 110 via an individual interface or a separate bus, rather than the common bus 170. For example, the processor 110 may be connected to at least one of the memory 120, the transceiver 130, the input interface device 140, the output interface device 150, and the storage device 160 via a dedicated interface.

The processor 110 may execute a program stored in at least one of the memory 120 and the storage device 160. The processor 110 may refer to a central processing unit (CPU), a graphics processing unit (GPU), or a dedicated processor on which methods in accordance with embodiments of the present disclosure are performed. Each of the memory 120 and the storage device 160 may be constituted by at least one of a volatile storage medium and a non-volatile storage medium. For example, the memory 120 may comprise at least one of read-only memory (ROM) and random access memory (RAM).

The storage device 160 may store information on the module generation request received from the user, information on the module registration request received from the user, the module list provided to the user, information on the modules selected by the user from the module list, and information on the smart data platform generation request received from the user.

Here, when executed by the processor, the at least one instruction may cause the apparatus to receive a module generation request from a user; generate a module according to the module generation request and transmitting the module to the user; receive a module registration request from the user; and register the module according to the module registration request.

Also, the at least one instruction may further cause the apparatus to generate a module list for the module registered according to the module registration request.

Meanwhile, the at least one instruction may further cause the apparatus to generate a smart data platform including a plurality of modules.

In the generating of the smart data platform, the at least one instruction may further cause the apparatus to receive a smart data platform generation request from a user; transmit a module list including a plurality of modules to the user; receive information on a module selected from the module list from the user; and generate the smart data platform based on the information on the selected module.

FIG. 5 is an operational flowchart illustrating an operation of a module management method according to another exemplary embodiment of the present disclosure.

Referring to FIG. 5, a module management method according to another exemplary embodiment of the present disclosure, as a method of managing modules by the module management apparatus, may comprise a step S510 in which the module generation unit 102 of the module management apparatus receives a module generation request from a user.

Here, the user's module generation request may include general module information such as authentication information, a module name, a module description, and a license. Subsequently, the module generation unit 102 may check whether or not there is an incorrect value in the user's module generation request. For example, if the user omits the general module information, the reception of the module generation request should be performed again.

If there is no incorrect value in the user's module generation request, the module generation unit 102 of the module management apparatus may generate a module and transmit it to the user (S520). If there is no abnormality when executing the generated module, the user may transmit a module registration request to the module management apparatus, and the module registration unit 105 of the module management apparatus may receive the module registration request from the user (S530). Subsequently, the module registration unit 105 may check whether there is no incorrect value in the user's module registration request. For example, it may be checked whether an API validator, API processor, or API hooker is included in a structure of the module.

If there is no incorrect value in the user's module registration request, the module registration unit 105 may register the module in the module storage unit 101 (S540). Meanwhile, the module management apparatus may generate a module list reflecting the module registered according to the module registration request.

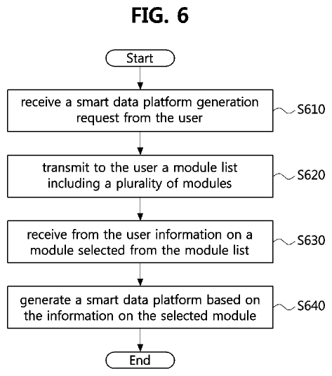

FIG. 6 is an operational flowchart illustrating a method of generating a smart data platform.

Referring to FIG. 6, a method of generating a smart data platform may comprise a step S610 in which the platform generation unit 103 of the module management apparatus receives a smart data platform generation request from the user.

Here, the user's smart data platform generation request may include general platform information such as authentication information, a platform name, a platform description, a license, and a platform purpose. Subsequently, the platform generation unit 103 may check whether or not there is an incorrect value in the user's smart data platform generation request. For example, if the user omits the general platform information, the reception of the smart data platform generation request should be performed again.

If there is no incorrect value in the user's smart data platform generation request, the module recommendation unit 104 of the module management apparatus may transmit a module list including a plurality of modules to the user (S620). Here, the module list may be a module list including a plurality of modules suitable for the user, which are identified through an analysis model generated according to current input information and a machine learning process based on the user's request.

Subsequently, when the user selects a plurality of modules from the module list, the module management apparatus may receive information on the selected modules (S630). Here, the information on the modules selected from the module list may be information on the modules selected by the user from the module list based on a keyword search.

In addition, the method may comprise a step S640 of generating a smart data platform based on the information on the selected modules.

The operations of the method according to the exemplary embodiment of the present disclosure can be implemented as a computer readable program or code in a computer readable recording medium. The computer readable recording medium may include all kinds of recording apparatus for storing data which can be read by a computer system. Furthermore, the computer readable recording medium may store and execute programs or codes which can be distributed in computer systems connected through a network and read through computers in a distributed manner.

The computer readable recording medium may include a hardware apparatus which is specifically configured to store and execute a program command, such as a ROM, RAM or flash memory. The program command may include not only machine language codes created by a compiler, but also high-level language codes which can be executed by a computer using an interpreter.

Although some aspects of the present disclosure have been described in the context of the apparatus, the aspects may indicate the corresponding descriptions according to the method, and the blocks or apparatus may correspond to the steps of the method or the features of the steps. Similarly, the aspects described in the context of the method may be expressed as the features of the corresponding blocks or items or the corresponding apparatus. Some or all of the steps of the method may be executed by (or using) a hardware apparatus such as a microprocessor, a programmable computer or an electronic circuit. In some embodiments, one or more of the most important steps of the method may be executed by such an apparatus.

Although the present disclosure has been described with reference to preferred embodiments, it will be apparent to those skilled in the art that the present disclosure may be variously changed and modified without departing from the spirit and scope of the invention defined in the following claims.

What is claimed is:

1. A method for managing modules, performed by a module management apparatus, the method comprising:
receiving a module generation request from a user;
generating a module according to the module generation request and transmitting the module to the user;
receiving a module registration request from the user; and
registering the module according to the module registration request.

2. The method according to claim 1, further comprising generating a module list for the module registered according to the module registration request.

3. The method according to claim 2, wherein the module list is composed of a plurality of modules associated with a function performed by the generated module for which the registration is requested.

4. The method according to claim 1, further comprising generating a smart data platform including a plurality of modules.

5. The method according to claim 4, wherein the generating of the smart data platform comprises:
receiving a smart data platform generation request from a user;
transmitting a module list including a plurality of modules to the user;
receiving information on a module selected from the module list from the user; and
generating the smart data platform based on the information on the selected module.

6. The method according to claim 5, wherein the information on the module selected from the module list is information on the module selected by the user from the module list through a keyword search.

7. A module management apparatus comprising:
a processor; and
a memory storing at least one instruction executable by the processor,
wherein when executed by the processor, the at least one instruction causes the module management apparatus to:
receive a module generation request from a user;
generate a module according to the module generation request and transmit the module to the user;
receive a module registration request from the user; and
register the module according to the module registration request.

8. The module management apparatus according to claim 7, wherein the at least one instruction further causes the module management apparatus to generate a module list for the module registered according to the module registration request.

9. The module management apparatus according to claim 8, wherein the module list is composed of a plurality of modules associated with a function performed by the generated module for which the registration is requested.

10. The module management apparatus according to claim 7, wherein the at least one instruction further causes the module management apparatus to generate a smart data platform including a plurality of modules.

11. The module management apparatus according to claim 10, wherein in the generating of the smart data platform, the at least one instruction further causes the module management apparatus to:
receive a smart data platform generation request from a user;
transmit a module list including a plurality of modules to the user;
receive information on a module selected from the module list from the user; and
generate the smart data platform based on the information on the selected module.

12. The module management apparatus according to claim 11, wherein the information on the module selected from the module list is information on the module selected by the user from the module list through a keyword search.
